(19) United States
(12) Patent Application Publication
(10) Pub. No.: US 2011/0006496 A1
(43) Pub. Date: Jan. 13, 2011

(54) Trolley

(75) Inventor: German Enrique Knoppers, Oude Leede (NL)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: AEROCAT B.V., Tilburg (NL)

(21) Appl. No.: 12/666,800

(22) PCT Filed: Jun. 27, 2008
(86) PCT No.: PCT/NL08/00165

§ 371 Date: Dec. 26, 2009

(30) Foreign Application Priority Data
Jun. 28, 2007 (NL) 1034054

(51) Int. Cl. B62B 3/00; A47B 81/00; A47B 23/00; A47B 91/00

(52) U.S. Cl. 280/79.11; 312/352

(57) ABSTRACT

A trolley (1) is described for distributing for instance food in aisles of airplanes. The trolley comprises a cabinet-shaped body (10) comprising a bottom (11), an upper wall (12), and two side walls (13) which enclose an interior (16), and which are manufactured as an extrusion part from plastic, for instance polyetherimide (PEI) or polyphenylsulphon (PPSU). The body is constituted as a combination of two body parts (20) coupled together, each with a substantially C-shaped contour. The body parts are double-walled, wherein an inner wall (21b, 22b, 23b) and the corresponding outer wall (21a, 22a, 23a) are connected with each other by a foam (29) or a system of plate-shaped ribs (30), wherein adjacent ribs have an opposite obliqueness. At its upper side, the body is provided with coextruded coupling members (50) for a tray, and at its under side the body is provided with co-extruded coupling members (70) for a wheel carrier (80) to which wheels (89) are connected.

The invention relates in general to a catering trolley or serving trolley for use in airplanes.

Such catering trolleys are generally known. They comprise a cabinet-shaped body, at least one door, an upper panel, wheels, etc. The trolleys are used for presenting for instance meals and drinks, or other articles, to airplane passengers, the trolleys riding through the aisle of the airplane, pushed or pulled by the serving cabin personnel.

Some important requirements are set to such trolleys. A first requirement concerns safety and strength. The trolleys must be able to withstand heavy loads, and must meet severe fire-safety requirements. In order to meet these requirements, trolleys are traditionally made of aluminium, in which case for instance wall panels are fixed to a frame. However, this has some disadvantages. Because the aluminium trolleys consist of multiple aluminium parts, manufacturing and assembling is relatively expensive. Further, aluminium is susceptible to damages such as dents and cracks, and is therefore relatively expensive in maintenance. Furthermore, an important disadvantage is that aluminium trolleys are relatively heavy, while especially in the world of airplanes there exists a desire for as much weight reduction as possible.

The present invention aims in general to solve or at least reduce the said disadvantages.

More particularly, the present invention aims to provide a trolley with a relatively low weight, of which the costs of manufacturing and maintenance are relatively low, while nevertheless the requirements of safety and strength are met.

The cabinet-shaped body of a trolley has a bottom, an upper wall, and two side walls, and is provided with a front wall implemented as a door and a rear wall which is closed or also implemented as a door. In the case of aluminium trolleys, the bottom, upper wall and the two side walls are plate components that are fixed to a block-shaped frame. Hinges for the door are also fixed to this frame, and the wheels below the trolley are screwed to the frame. According to an important aspect of the present invention, the bottom, upper wall and side walls of the cabinet-shaped body are manufactured as a self-supporting extrusion part from plastic; hereby, it is possible to omit the frame, which yields a substantial weight reduction. The plastic used will typically be a thermoplast, selected to meet the requirements of strength and fire-safety although at least in principle it is also possible that the plastic used has thermo hardening properties. A suitable selection is poleyetherimide (PEI) or polyphenylsulphon (PPSU), or a blend of at least one of these materials, but the present invention is not restricted to the application of these materials.

An important advantage of manufacturing as extrusion product is that it is possible to fabricate a product of “infinite” length and subsequently saw or cut it to size. Further, the advantage is achieved that the cabinet, at least in the case of large numbers, can be manufactured with less costs.

As will be described later more elaborately, the bottom, upper wall and side walls of the cabinet-shaped body are provided with several auxiliary parts, such as for instance rails at the inner side of the side walls for carrying catering trays, coupling members at the outside of the upper wall for mounting a tray, coupling members at the outside of the bottom for mounting wheels, etc. In the state of the art, such components are individually mounted to the wall parts, which is labor-intensive and expensive and requires much time. An important advantage of manufacturing as extrusion product is that it is possible to form such auxiliary parts as an integral component in the extrusion step, without any final processing being necessary.

Primarily, it is preferred that the body is manufactured as one single extrusion part with a substantially O-shaped contour. It is however possible that manufacturing such products is too complicated for a manufacturer. Therefore, it is also possible to manufacture the body as a combination of two or more extrusion parts that are attached to each other to form the body together. Then, the number of extrusion parts is preferably as small as possible.

In a favorable embodiment variation, the body consists of two extrusion parts, each having a substantially C-shaped contour, in which case each extrusion part comprises the complete side wall, a part of the bottom and a part of the upper wall of the cabinet. Particularly, each extrusion part comprises two corner segments, i.e. the corner segment between side wall and bottom and the corner segment between side wall and upper wall. The two extrusion parts are attached to each other at their free end edges; in this case, seams are formed in the bottom and upper wall which extend in the longitudinal direction of the trolley. In this case, it is specifically preferred that the two extrusion parts are mutually identical because this reduces the costs of manufacturing and logistic.

In another favorable embodiment variation, the body consists of two extrusion parts, each with a substantially U-shaped contour or inverse-U-contour, respectively, in which case each extrusion part comprises the complete bottom and two lower parts of the side walls or the complete upper wall and two upper parts of the side walls, respectively. Particularly, each extrusion part comprises two corner segments, i.e. the corner segments between side walls and bottom or the corner segments between side walls and upper wall, respectively. The two extrusion parts are connected to each other at their free end edges; in this case, seams are form in the side walls which are directed in the longitudinal direction of the trolley.

In yet another favorable embodiment variation, the body consists of four extrusion parts, each having a substantially L-shaped contour, in which case each extrusion part comprises a bottom part and a side wall part or a upper wall part and a side wall part, respectively. Particularly, each extrusion part comprises a corner segment, i.e. the corner segment between side wall and bottom or the corner segment between side wall and upper wall, respectively. The four extrusion parts, which may be mutually identical two by two, are connected to each other at their free end edges; in this case, seams are formed in the side walls, bottom and upper wall which extend in the longitudinal direction of the trolley. If desired, it is in this embodiment variation possible to increase the number of extrusion parts, in which case always four extrusion parts with a substantially L-shaped contour are present as well as a number of flat plate parts, also shaped as extrusion parts, in which case the resulting number of seams will then be larger.

For connecting together two of such extrusion parts, several joining techniques will be usable, gluing being preferred.

In general, it is desirable to implement the cabinet as strong as possible but also as light as possible. Actually, these are mutually opposite wishes, because strength can be achieved by increasing the wall thickness and weight reduction can be achieved by reducing the wall thickness. In order to be able to meet both of these whishes, the present invention proposes to implement the cabinet walls double-walled, i.e. with two relatively thin inner or outer walls respectively, with a connection construction in between which connects the inner wall to the outer wall in a strength-increasing manner, in which case an insulating effect is achieved as well.

In a first embodiment variation, this connection construction consists of a system of ribs, each rib lying in a plane extending in the longitudinal direction of the cabinet. At least a part of the ribs lies in a plane that connect the inner wall with the outer wall. The ribs may be perpendicular to the inner wall and the outer wall, in which case the ribs are mutually parallel and in cross-section are perpendicular to the inner wall and the outer wall. However, it is preferred that the ribs in cross-section are oblique to the inner wall and the outer wall, subsequent ribs having an opposite obliqueness so that the connection construction in cross-section defines a triangular contour. For increasing the insulation value, there may also be ribs extending parallel to the inner wall and outer wall. Such connection construction can easily be implemented in an extrusion process.

In a second embodiment variation, this connection construction consists of a foam, which is co-extruded on manufacturing of the extrusion parts between the inner wall and the outer wall. It is noted that such co-extrusion process is known per se and requires no further explanation.

Eventually, the intention is that a trolley has multiple removable trays in its interior, with for instance meals for distribution thereon. To this end, the side walls of the trolley at the inner side are provided with horizontal rails extending to the interior of the trolley. In the case of aluminium trolleys, these rails are connected to the inner wall as separate components. A disadvantage of this is the necessity of additional mounting actions. Further, it is a disadvantage that cleaning the inevitable joints and cracks in a hygienic manner is relatively difficult.

According to the present invention, this problem is solved by co-extruding to the extrusion parts a rail projecting from the inner wall. Thus, joints and cracks can be avoided completely which increases the hygiene of the trolley and reduces the cleaning costs. The rail may be a solid rail, but for sake of weight reduction it is also possible that the rail is a hollow rail.

It is noted that the international patent publication WO 2006/093410 discloses a trolley of which the cabinet body is manufactured of a plastic material in a sandwich construction, consisting of an inner wall, an outer wall and a honeycomb structure in between. In that case, the bottom and the two side walls of the cabinet are manufactured as a whole into a form piece with a U-shaped contour, namely by folding a plate-shaped panel along two fold lines. In that case, it is necessary to take away a part of the inner wall along the fold lines, in order to make folding possible, and after folding the remaining crack must be made water-tight by applying a sealing agent. These are processing steps to be executed on the panel, which make the manufacturing process relatively complicated and expensive.

It is further noted that the international patent publication WO-97/01475 discloses a trolley of which the cabinet body is manufactured of a plastic material in a sandwich construction, consisting of an inner wall, an outer wall and a foam in between. In that case, always a side wall and half a bottom and half an upper wall of the cabinet are manufactured as a whole to a form piece with a C-contour; however, this form piece is not an extrusion product.

These and other aspects, features and advantages of the present invention will be further clarified by the following description with reference to the drawings, in which same reference numerals indicate same or similar parts, and in which:

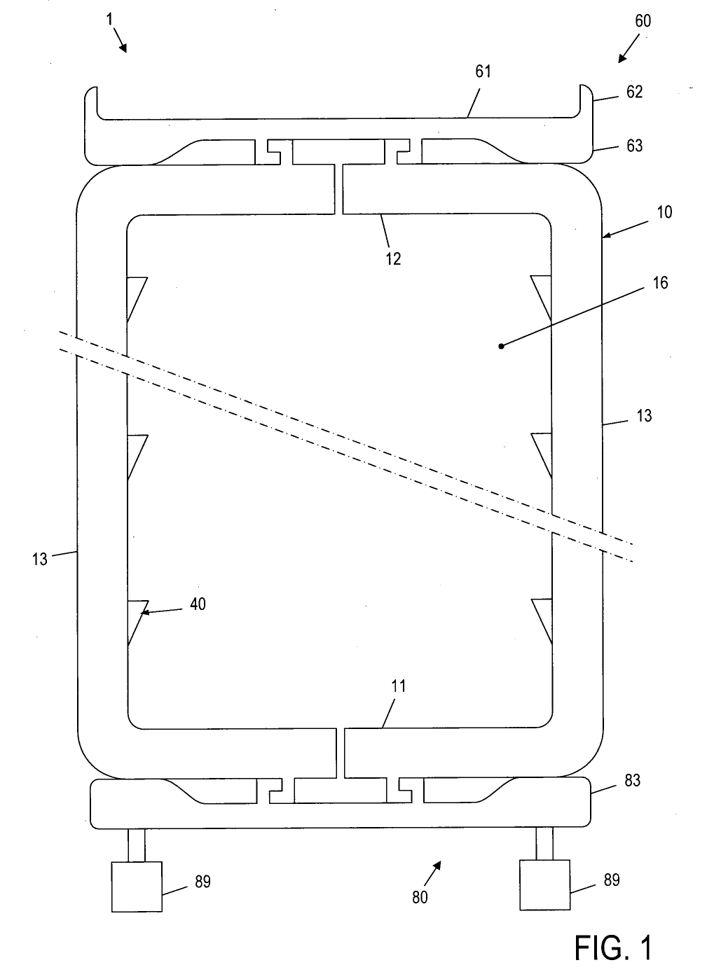

FIG. 1 is a schematical front view of a trolley;

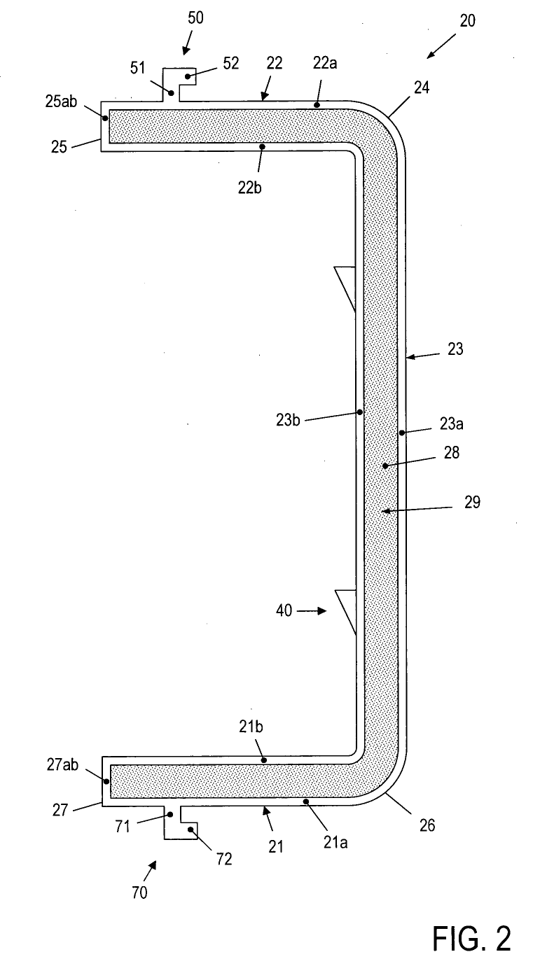

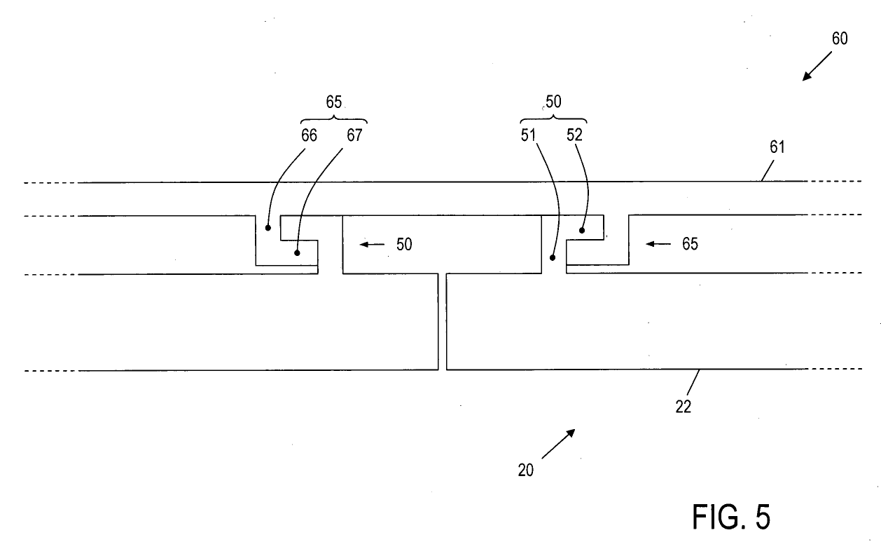

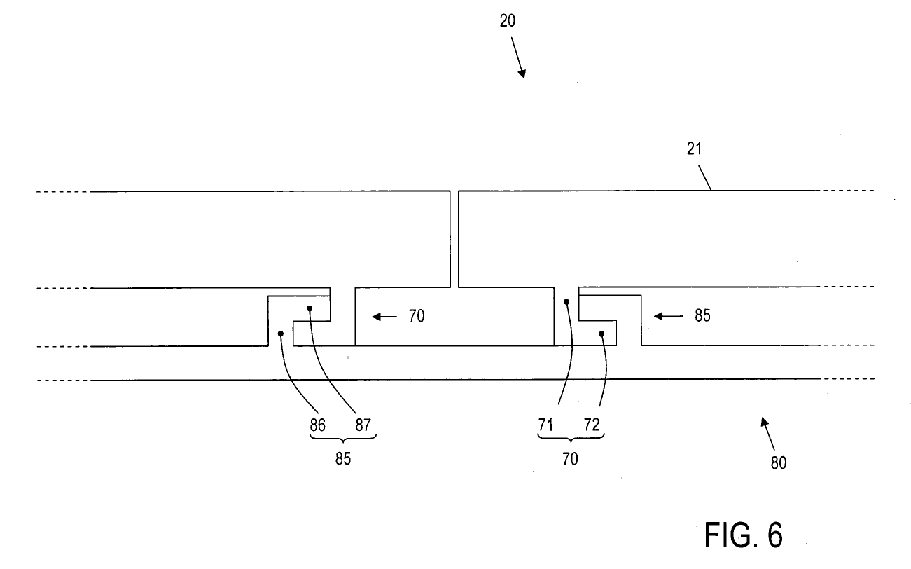

FIGS. 2-8 schematically (not to scale) show details of the construction of the trolley.

FIG. 1 is a schematic front view of a trolley indicated in general with reference numeral 1, in which for sake of simplicity the doors are left away. The trolley 1 is suitable to be used in aisles of airplanes, although other applications are also conceivable, for instance in aisles of trains or busses. Thus, the trolley has a relatively small width (horizontally in FIG. 1) which is sufficiently smaller than the aisle width concerned. The height of the trolley is typically in the order of about 1 meter. The direction of the trolley perpendicular to the plane of drawing of FIG. 1 corresponds to the longitudinal direction of an aisle and will be indicated as the longitudinal direction of the trolley.

The trolley 1 has a cabinet-shaped body 10, with a substantially plate-shaped bottom 11, substantially plate-shaped upper wall 12, and substantially plate-shaped side walls 13, which enclose an interior 16. The bottom 11 and upper wall 12 are directed substantially horizontally and longitudinally, the side walls 13 are directed substantially vertically and longitudinally. Thus, the cabinet-shaped body 10 in cross-section has a substantially rectangular contour. A flat tray 60 is mounted on the upper wall 12. Wheels 89 are mounted below the bottom 11.

The trolley further has a front wall implemented as a door, and a rear wall which may be closed or which may also be implemented as a door, but this is not illustrated in this figure for sake of simplicity.

According to the invention, the cabinet shaped body 10 is formed as an extrusion part of plastic, preferably PEI or PPSU, but the present invention is not limited to applying these materials. Within the gist of the invention, it is preferred that the cabinet-shaped body 10 in its entirety is formed as a single extrusion part, which then in cross-section has a substantially rectangular contour. In the embodiment shown, the cabinet-shaped body 10 is constituted from two half body parts, each formed as extrusion part. In the following, it will be assumed that both body parts are mutually identical; this is not technically necessary, but does offer economical advantages. Because of this identically, both body parts will be indicated by the same reference numeral 20, and also the corresponding components thereof will be indicated by mutually identical reference numerals. If it is necessary to distinguish both halves from each other, a character A or B will be added to the reference numeral.

It is noted that, in the context of the present invention, the expression “extrusion part” is used to mean that the form piece concerned has obtained its shape in the extrusion process, by an extrusion mould correspondingly shaped, without a final processing being necessary. This, for instance, in contrast to an extruded flat plate which in a final processing step is bent to an L-contour (one corner) or U-contour or C-contour, respectively (two corners).

FIG. 2 shows a schematic cross section, not to scale, of a body part 20, in an orientation corresponding to the eventual operative situation. It is clear that the body part has a substantially C-shaped contour, with a central part 23 defining a side wall 13 of the cabinet-shaped body 10.

The body part 20 further has an upper horizontal part 22, forming a half of the upper wall 12 of the cabinet-shaped body 10, as well as a corner section 24 between the central part 23 and the upper horizontal part 22. The upper horizontal part 22 has a free end edge 25 directed away from the central part 23.

The body part 20 further has a lower horizontal part 21, forming a half of the lower wall 11 of the cabinet-shaped body 10, as well as a corner section 26 between the central part 23 and the lower horizontal part 21. The lower horizontal part 21 has a free end edge 27 directed away from the central part 23.

Within the basic gist of the present invention, it is possible that the body part 20 is solid, i.e. without hollow spaces consists of one and the same material. Preferably, however, as shown, the body part 20 is double-walled, which is to say that each of the plate-shaped parts 21, 22, 23 has an outer wall 21a, 22a, 23a and an inner wall 21b, 22b, 23b, the indications “inner” and “outer” being related to the interior 16 of the trolley 1. Also the corner sections 24 and 26, which as shown preferably do not form a sharp corner but are somewhat rounded and which therefore may also be indicated as curve sections, comprise outer curve wall parts 24a, 26a and inner curve wall parts 24b, 26b, which seamlessly connect the outer walls 22a, 23a, 21a and the inner walls 22b, 23b, 21b, respectively, to each other. At the free end edges 25 and 27, there are bridging wall parts 25ab, 27ab which connect the free end edge of the outer wall 22a, 21a with the free end edge of the inner wall 22b, 21b, respectively. The thickness of the inner and outer walls is substantially less than the thickness of the plate-shaped parts 21, 22, 23 concerned, so that the inner walls 21b, 22b, 23b, outer walls 21a, 22a, 23a, and bridging wall parts 25ab, 27ab enclose an interior 28, in which a connection construction 29 is located which connects the inner walls with the outer walls.

In an embodiment, the interior 28 is filled with a foam 29. The foam may have been formed simultaneously with the inner walls 21b, 22b, 23b, outer walls 21a, 22a, 23a, outside curve wall parts 24a, 26a, inside curve wall parts 24b, 26b and bridging wall parts 25ab, 27ab in a co-extrusion process. This is illustrated in FIG. 2. It is noted that such co-extrusion process is known per se and requires no further explanation.

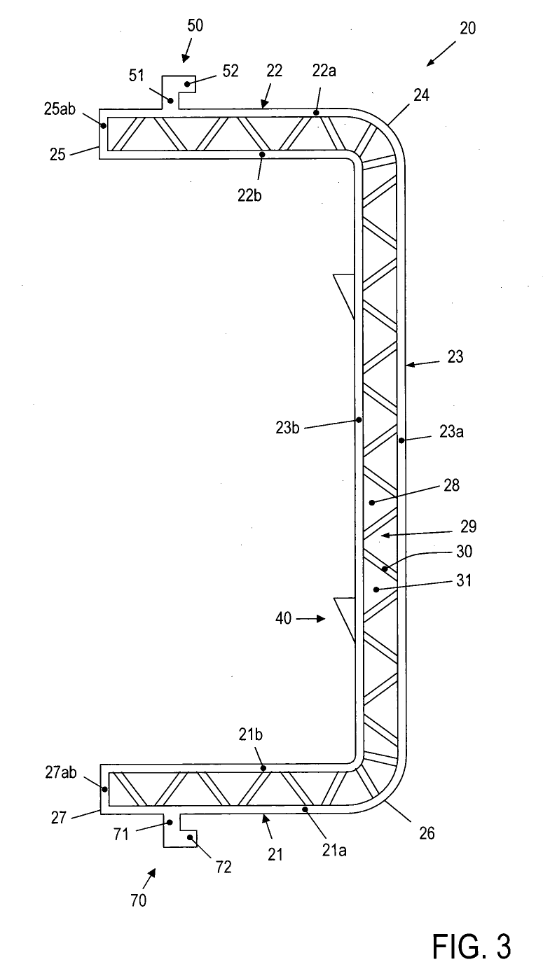

In another embodiment, illustrated in FIG. 3, this connection construction 29 comprises a system of substantially plate-shaped ribs 30, formed by extrusion together with the inner walls 21b, 22b, 23b, outer walls 21a, 22a, 23a, outside curve wall parts 24a, 26a, inside curve wall parts 24b, 26b, and bridging wall parts 25ab, 27ab, each rib being directed according to the longitudinal direction of the body part 20 and in cross-section connecting an inner wall 21b, 22b, 23b with the corresponding outer wall 21a, 22a, 23a. The ribs 30 may be mutually parallel and extend perpendicular to the inner wall and the outer wall. However, it is preferred that the ribs 30 are oblique to the inner wall and the outer wall, neighboring ribs 30 having an opposite obliqueness so that the ribs 30 together with the inner wall 21b, 22b, 23b and the corresponding outer wall 21a, 22a, 23a define hollow channels 31 having a triangular shape in cross-section and extending longitudinally.

A pattern of the ribs 30 differing from the pattern shown in FIG. 3 is also possible. FIG. 3A illustrates a variation in which a separation wall 32 is present parallel to the outer wall 23a and inner wall 23b, which separates the interior 28 in two parts, in which case there are ribs 33 connecting the inner wall 23b with this separation wall 32 and ribs 34 connecting the outer wall 23a with this separation wall 32. Hereby, a further improved thermal insulation is achieved.

Each side wall 13 of the body 10, on its inner surface facing the interior 16, is provided with a number of guide rails 40 extending longitudinally above each other, for placing thereon trays or horizontal separation walls (not shown). The number of guide rails 40 does not play a role for understanding the present invention, but will in general be larger than one.

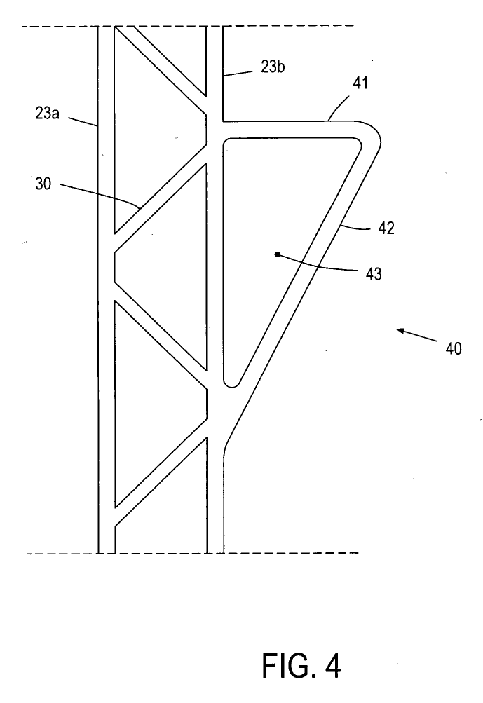

According to a further elaboration of the present invention, a guide rail 40 is formed as an integral part of the central part 23 of the body part 20 during the extrusion process. The guide rail 40 may be a solid rail, but the guide rail 40 preferably is a hollow rail, as shown in detail in FIG. 4. In the case of the embodiment illustrated in this figure, the guide rail 40 comprises a substantially horizontal strip 41 extending from the inner wall 23b to the interior 16. In the case of a sufficient thickness (vertical dimension) of the horizontal strip 41, it is possible that the guide rail consists exclusively of the horizontal strip 41; in that case, the guide rail 40 is solid. In the case of the embodiment shown, the guide rail 40 is hollow, and the guide rail 40 further comprises an oblique strip 42 below the horizontal strip 41, which extends from the inner wall 23b in an oblique manner upwards to the free end of the horizontal strip 41. The horizontal strip 41 and oblique strip 42 together with a corresponding part of the inner wall 23b enclose a hollow space 43; this design combines strength with weight reduction. Further, this design excels by the absence of joints and cracks between the guide rail 40 and the inner wall 23b, which promotes hygiene and simplifies cleaning.

It is noted that in the case of the design according to WO-97/01475, the guide rail is formed as a bulge of the inner wall 23b directed to the interior 16 of the cabinet, and thus directed away from the interior 28, as illustrated in FIG. 4A. This is however a weakening of the inner wall. In order to nevertheless give the inner wall sufficient strength, WO-97/01475 proposes to interrupt the guide rail in the longitudinal direction of the cabinet, so that the guide rail consists of multiple rail segments placed next to each other in the longitudinal direction, separated by interspaces where the inner wall extends as a flat wall from above to below, as indicated with a dotted line in FIG. 4A.

For mutually coupling the extrusion parts in order to assemble the body 10, the present invention proposes, as illustrated in FIG. 1, to provide a coupling rail 110 with a substantially I-shaped contour. The coupling rail 110, which may for instance be an extrusion profile from plastic, has a body 111, an upper flange 112 and a lower flange 113. Between the upper flange 112 and the lower flange 113, at opposite sides of the body 111, accommodation spaces 114a, 114b are defined for accommodating the free ends 25, 27 of the extrusion parts. These free ends are glued in the coupling rail with glue (not shown). This solution, which has proved itself in tests, is a relatively simple and cheap method for effecting a firm joint between the extrusion parts. However, other connection techniques and designs are also possible.

On the upper side of the body 10, typically a tray 60 is mounted, with a bottom 61 and upright side edges 62, of which in top view the contour substantially corresponds to the contour of the body 10, and thus substantially rectangular with rounded corners. The present invention further provides a simple and relatively cheap design for mounting such tray 60 on top of the trolley. As shown in detail in FIGS. 2, 3 and 5, a coupling member 50 is formed on the upper surface of the upper horizontal part 22. In the example shown, the upper horizontal part 22 has the same thickness everywhere, and the coupling member 50 thus projects above the upper surface of the upper horizontal part 22. However, if desired, it is also possible that the upper horizontal part 22 at the location of the coupling member 50 is implemented thinner, or that the coupling member 50 is sunken in the upper horizontal part 22, so that the coupling member 50 does not project above the upper surface of the upper horizontal part 22.

In the example shown, the coupling member 50 has an inversed L-shaped contour, with a leg part 51 being directed substantially perpendicular to the upper surface of the upper horizontal part 22, and a foot part 52 being directed substantially horizontally from the free end of the leg part 51, directed away from the free end edge 25 of the upper horizontal part 22.

It is conceivable that the coupling member 50 is formed as a separate part and is later connected to the body part 20, for instance by gluing or screwing. However, in a further elaboration of the gist of the invention, the coupling member 50 is formed during the extrusion process as an integral part of the horizontal part 22 of the body part 20. Then, the coupling member 50 has the form of a longitudinal rail parallel to the free end edge 25.

At the lower side of the bottom 61 of the tray 60, complementary coupling member 65 matching the two coupling members 50 are formed. In the example shown, each coupling member 65 has an L-shaped contour, with a leg part 66 being directed substantially perpendicular to the bottom 61 and a foot part 67 extending substantially horizontally from the free end of the leg part 66, wherein the two coupling members 65 are placed symmetrically with respect to each other and wherein the two foot parts are directed towards each other. Each coupling member 65 may be formed as a series of L-Shaped hooks placed next to each other, but preferably each coupling member 65 is formed as a longitudinal rail with an L-shaped cross-section, two rails mutually being parallel. The length of the two rail-shaped coupling members 65 is preferably substantially equal to the length of the rail-shaped coupling members 50, but this is not essential. In this example, it is possible to manufacture the tray as an extrusion product.

In order to mount the tray 60, the tray 60 is shifted longitudinally on the upper side of the body 10, over the two coupling members 50, wherein the two coupling members 65 at the lower side of the tray 60 engage the two coupling members 50 on the upper side of the body 10. The coupling members 50, 65, which provide a form-closing coupling, keep the tray fixed on the cabinet.

Depending on the tolerances used, the coupling members 50, 65 form a clamp fitting or allow some movement. From a manufacturing perspective, it may be desirable to use royal tolerances, which in that case lead to play, while in the finished product it is undesirable that the tray 60 has play with respect to the cabinet. In order to combine these two wishes with each other, it is possible that the coupling members 50, 65 are fixed with respect to each other, for instance by screws 53.

In a preferred embodiment, it is possible that the tray 60, through the coupling members 50, 65, performs a force transferring function, which reduces the load on the glue connection with the coupling rail 110.

The two coupling members 65 may at the under side project outside the tray 60, in which case a mounted tray seems to “float” above the body 10. It is also possible, as illustrated, that the tray 60 at the lower side of the bottom is provided with two mutually parallel ridges 63 below the edges 62, in order to visually close the space below the bottom 61, in the case of a mounted tray.

In the example described, there is one rail-shaped coupling member 50 on each body part 50, so that the upper face 12 of the cabinet 10 has two of such coupling members. The mutual distance between these mutually parallel coupling members may be chosen larger than shown schematically. Further, it is possible that there are multiple rail-shaped coupling members present next to each other.

In practice, it may be desirable to exchange the tray 60. In that case, the shifting movement in the longitudinal direction as described can lead to a quick exchange in a simple manner. In stead of the design described, which excels in simplicity, it is also possible to provide the tray 60 with coupling members which operate on the basis of a vertical movement for removing and placing the tray, for instance by means of a snap-fit.

What has been noticed in the above for mounting a tray on the upper side of the cabinet may also apply to mounting wheels on the lower side of the cabinet. In the preferred embodiment shown, as illustrated in the FIGS. 2, 3, 6, each body part 20 at its lower side is provided with a coupling rail 70 with a substantially L-shaped contour in cross-section, with a vertical leg part 71 and a horizontal leg part 72. For a further explanation, reference is made to the above explanation of coupling rail 50. Further, in this preferred embodiment a base plate 80 is provided, of which in top view the contour substantially corresponds to the contour of the body 10, thus substantially rectangular with rounded corners. The base plate 80 at its upper side is provided with two mutually parallel, complementary coupling rails 85 matching the two coupling rails 70 and having in cross-section a substantially inverse-L-shaped contour, with a leg part 86 directed substantially perpendicular to the base plate 80, and a foot part 87 directed substantially horizontally from the free end of the leg part 86, the two coupling members 85 being placed symmetrically with respect to each other and the two foot parts being directed towards each other.

For mounting the base plate 80 on the two body parts, the same applies, mutatis mutandis, as what has been described in conjunction with the tray 60, so that this description will not be repeated.

Further, as illustrated in FIG. 1, the base plate 80 at the upper side, along the side edges, is preferably provided with two mutually parallel ridges 83 in order to visually close the space above the base plate 80 in the case of a mounted base plate.

Wheels 89 are mounted at the lower side of the base plate 80. Because of this, it is no longer necessary to mount wheels to the body, but the wheels 89 together with the base plate 80, also indicated as wheel carrier, can be built together to a wheel base unit, which can simply be mounted below the body 10 by a shifting movement, and which also, through the coupling members 70, 80, can perform a force-transferring function, reducing the load of the glue connection with the coupling rail 110.

It is noted that the wheel base unit may further be provided with a braking mechanism for blocking the wheels when the trolley must stand still. Since such braking mechanisms are known per se, and the present invention does not relate to improving such braking mechanisms, a further description of design and operation of such braking mechanisms will be omitted.

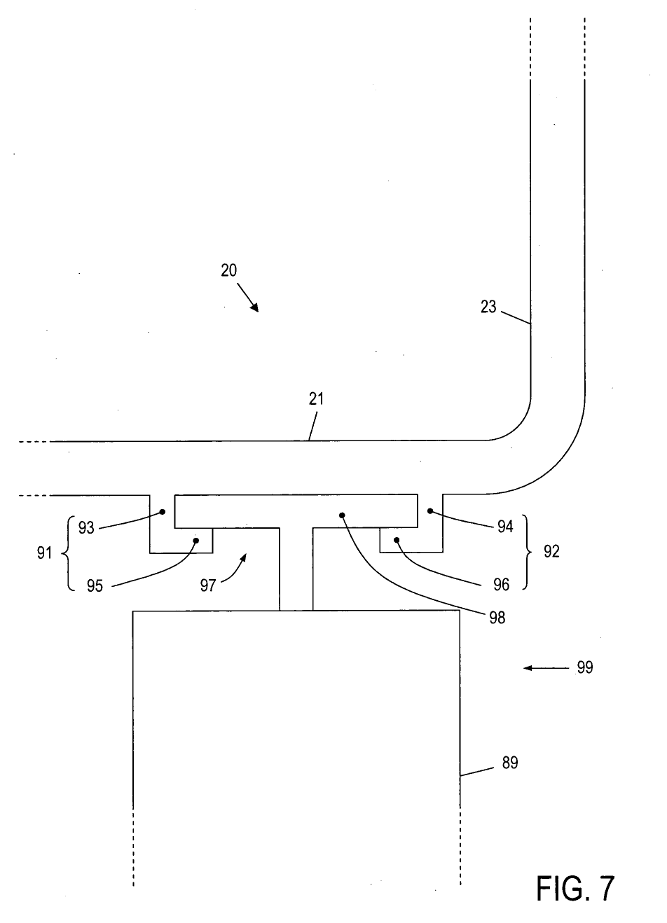

In the above described embodiment, all wheels are mounted to a single, common wheel carrier 80. Alternatively, it would be possible that the wheels are mounted to the body 10 individually. In that case, it is favorable if each body part 20 is further provided with two mutually parallel, substantially L-shaped mounting rails 91, 92, each with a vertical leg part 93 and 94, respectively, and a horizontal foot part 95 and 96, respectively, the foot parts 95, 96 being directed towards each other. These mounting rails 91, 92 then define an accommodation space 97 in which a mounting plate 98 of a wheel unit 99 can be shifted, as schematically illustrated in FIG. 7. It is noted that, in each accommodation space 97, two of such wheel units 99 will be mounted, on the front side and rear side of the trolley, respectively.

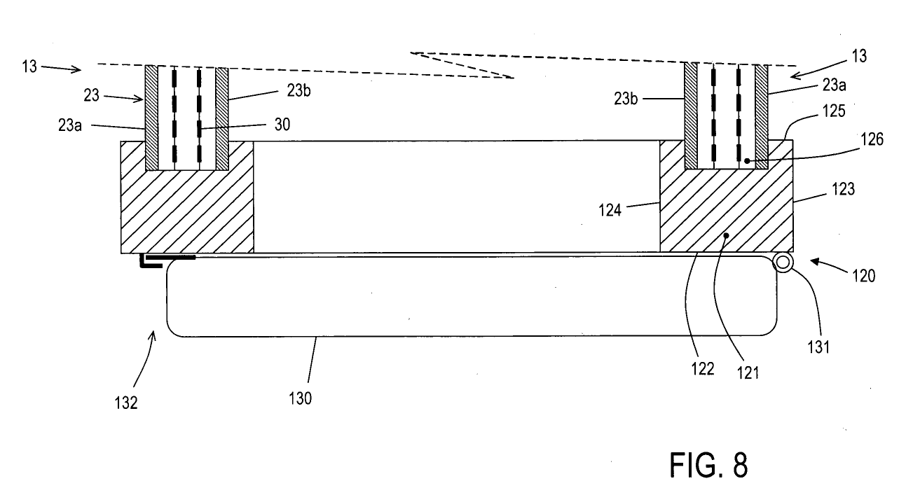

Further, a door construction is attached to the cabinet. This is known per se, and illustrated in WO-97/01475, so that it is not necessary to give an elaborate description of the door construction. A possible embodiment variation will be briefly described with reference to FIG. 8, which shows a top view in cross-section of a front end of the cabinet 10 in the implementation according to FIG. 3. The longitudinal direction of the cabinet in this figure is directed vertically. The lamellae 30 are symbolized by vertical dotted lines. In this embodiment, a frame 120 is provided with a contour corresponding to the frontal contour of the cabinet 10, thus a substantially rectangular O-contour. The frame has four frame beams 121, respectively corresponding to the side walls 13, the bottom 11 and the upper wall 12 of the cabinet 10. In cross-section, each beam 121 here has a substantially rectangular contour, with a front face 122, side faces 123, 124 and a rear face 125. In the rear face 125, a trough-shaped recess 126 is formed, which functions as accommodation space for the longitudinal end of the cabinet. More particularly, FIG. 8 shows that the longitudinal end of the side wall 13 is accommodated in the trough-shaped recess 126. The frame is fixed, for instance by gluing. Hinge components 131 and ledge-components 132, which for sake of simplicity are shown here only schematically, are formed or connected to the frame for a door 130 which for sake of simplicity is also shown here only schematically.

It is further noted that a vertical frame beam 121 encloses the frontal end of the corresponding side wall 13 with a U-shaped fitting. As noted above, support rails 40 are co-extruded on the inner side of the side wall 13; therefore, these in principle extend over the entire longitudinal dimension of the cabinet. In order to allow for the applying of the frame 120, the longitudinal ends of the support rails 40 may be removed over a small length, corresponding to the depth of the trough-shaped recess 126, or the rear face 125 of a vertical frame beam 121 is provided with further recesses for accommodating the longitudinal ends of the support rails 40. Similar remarks apply, mutatis mutandis, with respect to the coupling members 50, 70, 91, 92.

It will be clear to a person skilled in the art that the invention is not limited to the exemplary embodiments discussed in the above, but that several variations and modifications are possible within the protective scope of the invention as defined in the attached claims.

For instance, it is possible that multiple rail-shaped coupling members 50 are present on the upper side of the body 10, mutually parallel, and/or that multiple rail-shaped coupling members 65 are present on the lower side of the tray 60, mutually parallel.

Further, an embodiment is conceivable where the rail-shaped coupling members are not co-extruded.

Further, an embodiment is conceivable where the bottom (11), the upper wall (12), and the two side walls (13) of the body (10) are implemented double-walled without the body (10), whether or not in the shape of two body parts (20) coupled together with each having a substantially C-shaped contour, being shaped by extrusion. In this case, at least the discussed advantages of the double-walled embodiment are achieved.

Further, an embodiment is conceivable where the body (10) is implemented in the shape of two body parts (20) coupled together, with each having a substantially C-shaped contour, which are coupled together by a tray (60) on the upper side and/or a wheel carrier (80) on the lower side, without the body (10) being formed by extrusion, and/or without the body (10) being implemented double-walled.

Further, it should be clear that a serving trolley which is not used in a airplane, for instance for use in a hospital, nursing home, elderly home, also falls under the protective scope.

Further, the favorable insights of the present invention can also be implemented with stationary cabinets without wheels.

Features which have only been described for a certain embodiment can also be applied with other described embodiments.

1. Trolley comprising a cabinet-shaped body comprising a bottom, an upper wall, and two side walls which enclose an interior;
wherein the body comprises at least one extrusion part manufactured from plastic, which comprises at least a curve section between a side wall part and an upper wall part or a bottom part, respectively.

2. Trolley according to claim 1, wherein an extrusion part has a substantially O-shaped contour and comprises four curve sections.

3. Trolley according to claim 1, wherein an extrusion part has a substantially C-shaped contour, wherein each extrusion part comprises a side wall of the body, a part of the bottom of the body, a part of the upper wall of the body, as well as two curve sections.

4. Trolley according to claim 3, wherein the body is constituted as a combination of two extrusion parts coupled together.

5. Trolley according to claim 4, wherein the two extrusion parts are mutually identical.

6. Trolley according to claim 1, wherein an extrusion part has a substantially U-shaped contour, and comprises the bottom of the body as well as lower parts of the side walls of the body as well as two curve sections.

7. Trolley according to claim 1, wherein an extrusion part has a substantially inverse-U-contour, and comprises the upper wall of the body as well as upper parts of the side walls of the body as well as two curve sections.

8. Trolley according to claim 1, wherein an extrusion part has a substantially L-shaped contour, and comprises an end part of the bottom of the body as well as a lower part of the side wall of the body as well as a curve section.

9. Trolley according to claim 1, wherein an extrusion part has a substantially L-shaped contour, and comprises an end part of the upper wall of the body as well as an upper part of the side wall of the body as well as a curve section.

10. Trolley according to claim 1, wherein at least one of the extrusion parts is made of a material selected from the group consisting of polyetherimide (PEI), a polyetherimide-comprising blend, polyphenylsulphon (PPSU), and a polyphenylsulphon-comprising blend.

11. Trolley according to claim 1, wherein the cabinet-shaped body is implemented as a self-supporting frameless body.

12. Trolley according to claim 1, wherein an extrusion part is implemented double-walled, and comprises a relatively thin inner wall, a relatively thin outer wall, and in between a connection construction which connects the inner wall to the outer wall.

13. Trolley according to claim 12, wherein the connection construction comprises a foam.

14. Trolley according to claim 12, wherein the connection construction comprises a system of plate-shaped longitudinal ribs.

15. Trolley according to claim 14, wherein the ribs are oblique to the inner wall and the outer wall, wherein neighboring ribs have an opposite obliqueness.

16. Trolley according to claim 12, wherein the inner wall, outer wall and connection construction are manufactured by extrusion or co-extrusion, respectively.

17. Trolley to claim 1, wherein each side wall is provided with at least one support rail projecting from the inner surface thereof to the interior, for placing trays or horizontal separation walls thereon, wherein the support rail is formed integrally with the side wall part concerned during the extrusion process.

18. Trolley according to claim 17, wherein the guide rail is a hollow rail.

19. Trolley according to claim 17, wherein the side wall part concerned is implemented double-walled, and comprises a relatively thin inner wall, a relatively thin outer wall, and in between a connection construction connecting the inner wall with the outer wall, wherein the inner wall continues at the location of the guide rail.

20. Trolley according to claim 1, wherein the extrusion part is provided with at least one externally formed coupling member thereon, for connecting external components to the body;
wherein each of said coupling members is implemented as a rail-shaped coupling member which is formed integrally with the extrusion part concerned during the extrusion process.

21. Trolley according to claim 20, wherein each of the said coupling members has a substantially L-shaped contour with a substantially vertical leg part and a substantially horizontal foot part.

22. Trolley according to claim 21, wherein the body comprises at least two extrusion parts wherein coupling members arranged on adjacent extrusion parts have foot parts directed away from each other.

23. Trolley according to claim 22, wherein an externally attached part is provided with two complementary coupling members matching said coupling members and engaging said coupling members and forming therewith a form-closing and preferably force-transferring connection.

24. Trolley according to claim 20, wherein an externally attached part is implemented as a tray arranged on top of the body.

25. Trolley according to claim 20, wherein an externally attached part is implemented as a wheel carrier to which wheels are attached.

26. Tray, for mounting on a trolley according to claim 20, which tray has a bottom and, at the lower side of the bottom, is provided with at least two complementary coupling members matching with coupling members formed externally on the upper wall of the body and adapted to engage said coupling members and forming therewith a form-closing connection.

27. Tray according to claim 26, wherein each of the complementary coupling members has a substantially L-shaped contour, with a substantially vertical leg part and a substantially horizontal foot part.

28. Wheel carrier for mounting on a trolley according to claim 20, which wheel carrier at its upper side is provided with at least two complementary coupling members matching to coupling members formed externally below the bottom of the body, and adapted to engage said coupling members and to form therewith a form-closing connection.

29. Wheel carrier according to claim 28, wherein each of the complementary coupling members has a substantially L-shaped contour, with a substantially vertical leg part and a substantially horizontal foot part.

30. Trolley according to claim 20, wherein the body at its lower side is provided with at least two systems of two mutually parallel, substantially L-shaped wheel mounting rails, each with a vertical leg part and a horizontal foot part, wherein the foot parts are directed towards each other and thus define an accommodation space;
and wherein at least one mounting plate of a wheel unit is arranged in each accommodation space.

31. Body part for forming the body of a trolley according to claim 1, which body part has a substantially C-shaped contour with a central part defining a side wall of the cabinet-shaped body, an upper horizontal part defining a half of the upper wall of the cabinet-shaped body, and a lower horizontal part defining a half of the lower wall of the cabinet-shaped body, and further with two curve sections;
wherein the body part has at least one of the following features:
the body part is formed as an extrusion part manufactured from plastic;
the central part, the upper horizontal part, and the lower horizontal part are implemented double-walled, with a relatively thin inner wall, and a relatively thin outer wall, and in between a connection construction connecting the inner wall with the outer wall, wherein the connection construction comprises a foam or wherein the connection construction comprises a system of plate-shaped longitudinal ribs which are oblique to the inner wall and the outer wall wherein adjacent ribs have an opposite obliqueness;
each central part is provided with at least one preferably hollow support rail, projecting from the inner surface thereof, which rail is formed integrally during the extrusion process with the side wall part concerned, wherein the inner wall of the side wall part concerned continues at the location of the guide rail;
the body part is provided with at least one co-extruded rail-shaped coupling member externally on the upper horizontal part and/or externally below the lower horizontal part, having a substantially L-shaped contour, onto which complementary coupling members of a connection member can engage for forming a form-closing connection; and
the body part is provided with a system of two co-extruded, substantially L-shaped wheel mounting rails externally below the lower horizontal part, each having a vertical leg part and a horizontal foot part, wherein the foot parts are directed towards each other and thus define an accommodation space for a mounting plate of a wheel unit.

32. Trolley according to claim 1, the trolley suitable for distributing food in aisles of airplanes.
